(19) United States
(12) Patent Application Publication
(10) Pub. No.: US 2005/0071264 A1
(43) Pub. Date: Mar. 31, 2005

(54) System and method for creating and implementing a lease agreement

(75) Inventors: Trent Tsoa-Lee, Newport (AU); Michael Lee, Gorokan (AU)

Correspondence Address: John S. Egbert;Harrison & Egbert, 7th Floor, 412 Main Street, Houston, TX, 77002, US

(73) Assignee: FRP Pty Ltd., Newport (AU)

(21) Appl. No.: 10/438,796

(22) Filed: May 15, 2003

(30) Foreign Application Priority Data
May 15, 2002 (AU) PS 2338

(51) Int. Cl. G06F 17/60

(52) U.S. Cl. 705/38

(57) ABSTRACT

The present invention provides a method for creating and implementing a lease agreement between a lessor of an income generating property and a lessee of said property and preparing lease agreement documents specifying payment obligations of said lessee to said lessor concerning said property which is subject to said lease agreement including the steps of: determining an amount of rent payable and a term of lease; creating a promissory obligation by the lessor of said property to share with the lessee a quantum of benefits attributable to said agreement, said benefits being selected from the group consisting of equity based benefits and cash based benefits; and creating a promissory obligation by the lessee to make an investment in relation to said property, in addition to said rent payable, in consideration for said lessor's promissory obligation.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to an improved business relationship between a lessor of an income generating property and a lessee of said property and in particular creating multi-party lease agreements which combine the benefits of a traditional lease, an equity participation, and a partnership.

### BACKGROUND OF THE INVENTION

The traditional lessor-lessee relationship subjects lessors to various risks stemming from, among other factors, regular changes of lessees. As a result, under the current model:
The Lessor:
   Rents to people that they do not know for short periods.
   Suffers unpredictable cash flow and income loss through vacancy and late payment of rent.
   Often receives market set rent due to availability of comparable properties.
   Has little opportunity to set rental increases that are above market.
   Spends as little as possible on the property due to seemingly poor short-term returns on investment.
   Has only a small recourse (usually four weeks rent) to cover damage caused by unsuitable lessees.
The Lessee:
   Has only a short-term interest in the property.
   Treats the property as a rental and consequently takes less care than the owner would.
   Has limited security of tenure with very little recourse if the lessor chooses to terminate the lease.
   Pays the lowest rent possible in order to save money for other lifestyle choices (including saving to purchase their own property).
   Has only a limited incentive to pay rent on time.

These fundamental features of the traditional lease lead to inherent instability, unpredictability and most significantly, compromised profitability of the current model of business relationship between and lessor and a lessee.

### BRIEF SUMMARY OF THE INVENTION

The present invention aims to address one or more of these deficiencies by providing a new system and method for creating and implementing a lease agreement.

In one aspect, the present invention provides a method for creating and implementing a lease agreement between a lessor of an income generating property and a lessee of said property and preparing lease agreement documents specifying payment obligations of said lessee to said lessor concerning said property which is subject to said lease agreement including the steps of: determining an amount of rent payable and a term of lease; creating a promissory obligation by the lessor of said property to share with the lessee a quantum of equity based benefits and/or cash based benefits attributable to said agreement; and creating a promissory obligation by the lessee to make an investment in relation to said property, in addition to said rent payable, in consideration for said lessor's promissory obligation.

Preferably said payment obligations are based on an escalating scale.

In one preferred embodiment of the present invention, said method includes the step of creating a promissory obligation by the lessor of said property to share with the lessee a quantum of equity based benefits attributable to said agreement, and preferably further includes the step of creating a promissory obligation by the lessor of said property to share with the lessee a quantum of cash based benefits attributable to said agreement.

Said lessor may be the owner of said property. Also, said lessor may be a lessee of a master lease of said property and said lease agreement may be a sub-lease of said property. Alternatively, the lessor may be a part-owner of said property with said lessee.

Preferably said promissory obligation by the lessee includes an obligation to make an improvement of the property which is subject to the lease agreement. Preferably, said improvement is specified in a package, said package matched to a particular type of said property.

Preferably, said improvement is a capital improvement.

In another embodiment, said improvement is a renovation of the property which is subject to the lease agreement.

In another preferred embodiment, lessee's obligation includes an obligation to make additional rental payments. Preferably, said additional rental payments are based on an escalating scale.

Preferably, said escalating scales include variable rental increase rate and/or variable frequency of rental increases. Preferably said rental increase rate is equal to a multiple of, for example two times market average rate. Preferably, said frequency of rental increases is one rental increase per annum.

The method may further include the step of creating a loan agreement between said lessor and a lender, said loan agreement creating a promissory obligation by said lender to lend to said lessor, directly or indirectly, a loan amount in relation to said lease agreement. Said method may further include the step of creating a loan agreement between the lessee and a lender, said loan agreement creating a promissory obligation by the lender to lend to the lessee, directly or indirectly, a loan amount in relation to said lease agreement.

Preferably, said equity based benefits are determined on the basis of change in valuation of said property between an initial independent valuation performed at the beginning of said term of lease and a final independent valuation performed at the end of said term of lease.

Preferably, in agreements wherein the lessee makes an improvement to the property, said initial independent valuation is performed before and after said improvement takes place.

Preferably, said final valuation is indexed to allow for inflation. Said valuations may be performed by a lender, or by a third party approved by a lender, or by a third party chosen by the lessor and/or the lessee.

In another embodiment, said equity based benefits are capital gains. Preferably said capital gains are calculated by reference to a cost base for said property, which optionally is indexed to allow for inflation.

Preferably, the assessments of the value of the property at the beginning and at the end of the lease are of the same nature—either both are market set values (sale prices) or both are independent valuations.

Preferably, said cash based benefits include agreement based cash savings accumulated by the lessor. Preferably, said cash savings include savings on agent commission and/or savings on letting fees. Preferably, said cash based benefits include lessor's income attributable to increased occupancy rate. Preferably, said cash benefits also include lessor's income attributable to said escalating scale provisions.

In another embodiment, said method may further include the step of creating a promissory obligation by the lessor to provide an incentive in relation to said agreement. Said incentive may be presented as a gift by said lessor to said lessee. Also, a loan agreement may be entered by the lessor and a lender, said loan agreement creating a promissory obligation by said lender to lend a loan amount in relation to said incentive. Interest payments on said loan may be made by said lessee.

Said incentive may include a non-capital improvement of the property which is subject to said lease.

In another embodiment said method may further include the step of creating a promissory obligation by the lessor to make a capital improvement of the property which is subject to said lease agreement. Also, a loan agreement may be entered by said lessor and a lender, said loan agreement creating a promissory obligation by said lender to lend a loan amount in relation to said capital improvement.

Preferably, performance of said lessor's obligation is due at the end of said term of lease. Preferably, said term of said lease is at least 5 years.

In one preferred embodiment, said method further includes the step of creating a roll-over option available to the lessee at the end of said term of lease.

In another embodiment, said method further includes the step of selling of the property subject to said lease agreement. The lease agreement may give the lessee an option to purchase the whole or part of the lessor's interest in said property, or may give the lessee the right of first refusal on said sale of the property.

Alternatively, said method further includes the step of financing said property by the lessor to pay out the lessee.

Also, a loan agreement between said lessor and a lender may be entered into, said loan agreement creating a promissory obligation by said lender to lend a loan amount in relation to said pay out.

Preferably, in agreements wherein the lessee makes additional payments, said method may further include the step of determining a minimum guaranteed amount payable by the lessor to the lessee under said lessor's obligation. Preferably, said minimum guaranteed amount is determined by reference to a pre-determined annual return on the average lessee's investment outstanding during said lease agreement.

Also, in agreements wherein the lessee makes additional payments, said method further includes the step of setting a maximum return limit on said lessor's obligation. Preferably, said maximum return limit is calculated by reference to the difference between the old and the new yield on said property and by reference to said minimum guaranteed amount.

Preferably, the lease agreement further includes a Sub Let Clause that allows the Lessee to sublet the property to a Sub-Lessee with written consent of the Lessor. Preferably, consent to sub-lease does not release the Lessee from any obligations under the lease agreement nor does it entitle the Sub-Lessee to make any claims against the original lessor.

Preferably, the lease agreement further includes a Reinstatement Clause providing that any cleaning and/or damage repair above normal wear and tear is the responsibility of the Lessee and will be subtracted from the settlement amount prior to the payment to the Lessee.

In a preferred embodiment of the present invention, said method further includes the step of third party matching of said lessor with said lessee. Said matching may be performed by a lender.

Preferably, said step of matching said lessor with said lessee includes the steps of
creating a lessor-lessee matching database;
providing lessor data management tools allowing an operator to manage property data in said database, including the steps of
   creating a property description, and
   creating and modifying data for said property description;
providing lessee data management tools for an operator to create and modify property characteristics specific to a lessee;
accessing said lessor-lessee matching database;
forming a property query using said database and said property characteristics; and
searching said property data in said lessor-lessee database to return properties compatible with said property query.

Said step of matching said lessor with said lessee may include the steps of forming a property characteristics query using said database and said property description, and searching said property characteristics in said lessor-lessee database to return property characteristics compatible with said property characteristics query.

Preferably, search results are sorted and presented in descending order based on their weighted index score with the most relevant items at the top of the list.

Preferably, said lessor-lessee matching database is created in a form readable by a computer processor.

Preferably, in the creation and implementation of a lease agreement relating to a residential property, said lessor data management tools includes means for describing said property by specifying one or more of the following: the name of the lessor; the address of the lessor; the contact details of the lessor; an amount of rental payments; a term of lease; an investment contribution; type of said investment contribution; an incentive provided by said lessor; a quantum of equity based benefits; a quantum of cash based benefits; the address of the property; type of property; age of property; material of construction; condition of the property; whether the property is furnished; the number of bedrooms; the number of bathrooms; the availability and/or description of lounge room; the availability and/or description of living room; the availability and/or description of dining room; the availability and/or description of study; the availability and/or description of parking; the availability and/or description of yard; the availability and/or description of swimming pool; the availability and/or description of spa; the availability and/or description of internal laundry; whether or not a pet animal is allowed; views; images of the property, additional comments.

Preferably, in the creation and implementation of a lease agreement relating to a residential property, said lessee data management tools include means for specifying property characteristics specific to a lessee by specifying one or more of the following: the name of the lessee; the address of the lessee; the contact details of the lessee; an amount of rental payments; an investment contribution; type of said investment contribution; an incentive to be provided by a lessor; a preferable location of property; type of property; age of property; material of construction; condition of the property; the number of bedrooms; the number of bathrooms; the availability and/or description of lounge room; the availability and/or description of living room; the availability and/or description of dining room; the availability and/or description of study; the availability and/or description of parking; the availability and/or description of yard; the availability and/or description of swimming pool; the availability and/or description of spa; a pet animal; additional comments.

Said preferable location may be indicated by specifying lessee preferences on proximity to one or more nearest preference points, such preference points including one or more of the following: proximity to CBD; proximity to train line; proximity to bus line; proximity to restaurants; proximity to cafes; proximity to local shops; proximity to major shopping centres; proximity to beach; proximity to lakes; proximity to harbour; proximity to hotels; proximity to clubs; proximity to schools; proximity to childcare facilities. In such an embodiment, said method of matching further includes the step of accessing a map database.

In one preferred embodiment, said method further includes the step of using a computer system for preparing lease documents specifying equity based benefits.

Preferably, said method further includes the step of using a computer system for preparing lease documents specifying cash based benefits.

Preferably, said step of using said computer system includes the steps of:
inputting data into said computer system regarding terms of said lease, including an amount of rental payments and a term of lease;
using said computer system to calculate said payment obligations of said lessee accruing under said lease agreement;
using the computer system to prepare one or more lease documents which specify (1) equity based benefits, (2) cash based benefits; (3) that lessee is to make an investment in relation to said property, (4) that the lessee is entitled to share in a quantum of said benefits, and (5) calculation basis for said equity and cash based benefits.

The lease documents may specify that the lessor is to sell said property. Also, said lease agreement documents may specify that payment of all obligations owed by the lessor to the lessee is synchronised with the sale of the property subject to the lease.

Preferably, said documents specify an upper limit on said benefits or/and a minimum total guaranteed return for the lessee. Preferably, the minimum total guaranteed return for the lessee is determined by reference to a predetermined annual return on the average lessee's contribution outstanding during the lease period. Preferably, the maximum return limit is calculated by reference to the difference between the old and the new yield on said property and reference to the minimum total guaranteed return.

In another embodiment, a lessor-lessee matching database computer system may be used to match property data provided by a plurality of lessors to a plurality of property characteristics provided by a plurality of lessees. Preferably, the computer system includes a computer processor; a lessor-lessee matching database containing property data relating to a plurality of lessors in a form readable by said processor; property data stored in said database; database management tools to manage said property data in said database including: a tool for creating a property description and a tool for creating and modifying data for said property description; database management tools to manage data relating to property characteristics specific to a plurality of lessees; a software tool using said database and said property characteristics to form a property query; and a search tool searching said property data in said lessor-lessee matching database to return property descriptions compatible with said property query.

Said lessor-lessee matching database computer system may include a software tool using said database and said property description to form a property characteristics query, and a search tool searching said property characteristics in said lessor-lessee database to return property characteristics compatible with said property characteristics query.

Preferably said computer system further includes a map database.

In a preferred embodiment the lessor-lessee matching database computer system further includes at least one server computer configured to connect to a network for transferring and receiving data relating to said lessor-lessee database and the computer processor and the database management tools are connected to the network for transferring and receiving said data thereover.

The server computer may be a Web server configured to connect to the internet and to send a message over the internet, said message relating to data relating to the lessor-lessee matching database.

In another embodiment, the present invention provides a computer system for preparing lease agreement specifying payment obligations of a lessee to a lessor concerning an income generating property which is subject to a lease, the lease agreement including a promissory obligation by the lessor of said property to share with the lessee a quantum of equity based benefits attributable to said agreement. The computer system includes:
at least one computer including a central processing unit and a memory, for receiving data regarding the terms of the lease, including an amount of rental payments and a term of lease, within the computer system;
at least one computer calculating periodic payment obligations of the lessee accruing under said lease agreement, and preparing one or more lease documents which include a promissory obligation by the lessor of said property to share with the lessee a quantum of equity based benefits attributable to said agreement and which specify: (1) equity based benefits, (2) that lessee is to make an investment in relation to said property, and (3) that the lessee is entitled to share in a quantum of said benefits.

Preferably said computer system prepares documents which further include a promissory obligation by the lessor of said property to share with the lessee a quantum of cash based benefits attributable to said agreement and which specify the cash based benefits attributable to the agreement.

Preferably, said computer system further includes at least one server computer configured to connect to a network for transferring and receiving data relating to said lease agreement and said client computer is connected to said network for transferring and receiving said data thereover.

The server computer may be a Web server configured to connect to the internet and to send a message over the internet, said message relating to said lease agreement.

Also, the server computer may be configured to connect to at least one network to receive and transfer said lease documents over said network.

Loans referred to in the present invention may be interest only loans. Interest rates may be variable or fixed. Preferably, interest rates are fixed. Also, loan agreements entered by the lessor may be serviced/guaranteed by the lessee and vice versa.

### BRIEF DESCRIPTION OF THE VIEW OF THE DRAWING

Preferred embodiments of the invention will now be described by way of example with reference to the accompanying drawings, in which:

FIG. 1 is a schematic diagram showing the method of the system of the present invention.

FIG. 2 is a schematic diagram of a lessor-lessee matching database computer system.

FIG. 3 is a Lessor Basic Details screen shown at an operator interface of the system.

FIG. 4 is a Lessor Home Description screen for entering property information provided by a Lessor.

FIG. 5 is a Lessor Home Location screen for entering details of nearest preferred locations.

FIG. 6 is a Lessee Basic Details screen shown at an operator interface of the system.

FIG. 7 is a Lessee screen for entering Lessee home preferences details.

FIG. 8 is a Lessee screen for entering Lessee suburb preferences details.

FIG. 9 is a Lessee screen for entering Lessee home location preferences details; and

FIG. 10 is an operator screen showing search results summary.

### DETAILED DESCRIPTION OF THE INVENTION

The method and system for creating and implementing the lease agreement described in the present invention is intended for use by a lessor wishing to enter into a lease agreement relating to an income generating property and a lessee of said property. The invention also relates to the financing arrangements relating to property, in particular residential housing.

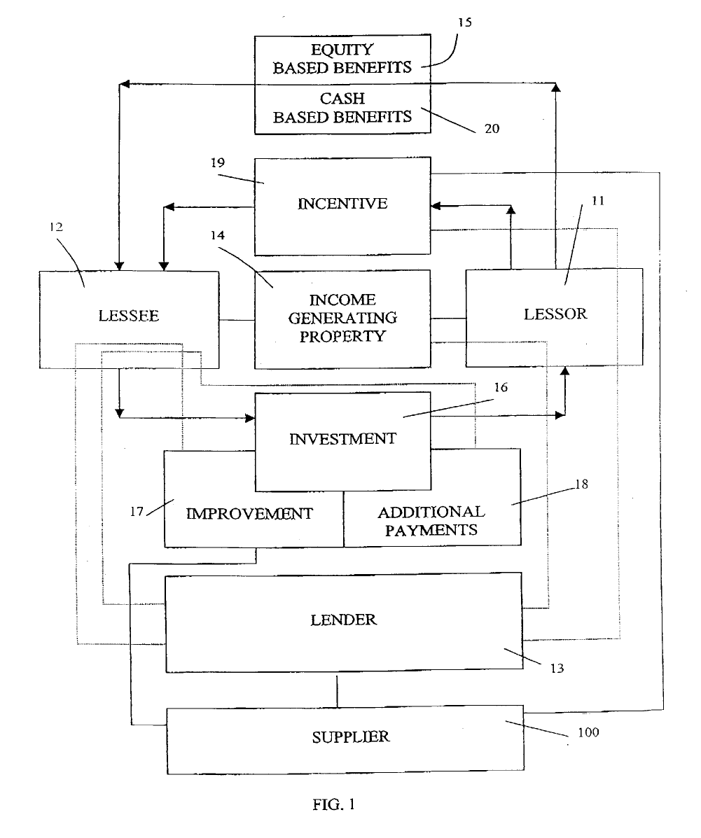

FIG. 1 depicts the overall method of the present invention and identifies the major parts and parties of a lease agreement, including a lessor 11, a lessee 12, a lender 13, and a supplier 100.

The new method and system for creating and implementing a lease agreement represents a unique methodology linking a traditional lease agreement between a lessor and a lessee to a quasi-partnership relationship between the parties, characterised by sharing benefits attributable to the lease agreement.

In lease agreements created with the subject invention, the lessor 11 retains the traditional ownership of the underlying property 14 which is subject to the lease agreement, but he immediately surrenders a quantum of equity based benefits 15 attributable to an investment 16 made by the lessee 12 in relation to the property 14. Such an investment may include a long-term improvement 17 to the property 14. Preferably, said improvement is a capital improvement. Preferably, said improvement is specified in a package provided by the supplier 100.

In another preferred embodiment, said investment may take the form of additional payments 18 made by the lessee in consideration for said quantum of equity based benefits 15.

An investment made by the lessee may be made in response to an incentive 19 provided by the lessor 11. Also, the lessee may make a hybrid investment through a combination of an improvement to the property and additional rental payments.

Further, in lease agreements created with the subject invention, the lessor may enter into a promissory obligation to share with the lessee a quantum of cash based benefits 20 attributable to the lease agreement. Also, the lessor may enter into a combined obligation which includes both equity based benefits 15 and cash based benefits 20.

The present invention also covers lease agreements with multi-party and third party obligations, one of which includes a lender's obligation to finance one or more of the following: (a) the investment made by the lessee, (b) the incentive provided by the lessor, (c) the leased property ownership, (d) the final settlement payout by the lessor to the lessee.

Further, a ‘loan’ provided by the lender includes a loan provided to a lessor and/or a lessee, directly or indirectly, in relation to the lease agreement.

Loans provided by said lender may be secured and/or unsecured. Also, said loans may be interest-only loans. In addition, the loan repayments may be split between the lessor and the lessee.

The lessor may be a lessee of a master lease, and the lease agreement created with the subject invention may be a sub-lease, a sub-sub-lease, etc.

The “lessor” includes the persons for a time being entitled to the reversion expectant on determination of the lease. Similarly, the lessee includes the successors in title. Whenever there is more than one lessee or lessor, all obligations can be enforced against all of the lessees/lessors and against each individually.

The invention also encompasses lease agreements involving joint ownership of the leased property, eg. a lease agreement between a lessor/owner/investor/developer and a lessee/owner/occupant. In such agreements, both the lessor and the lessee have title as co-owners, but the lessee/owner/occupant pays rent to the lessor/owner/investor for lessor's share of the property. Particularly, such arrangements are suitable for a parent and a child.

As part of the creation and implementation of lease agreements, the method includes the step of calculating equity based benefits attributable to the agreement. Generally, the methodology for calculating equity based benefits is determined by the form of agreed final settlement of the lease.

Preferably, the equity based benefits are determined on the basis of change in valuations of the leased property between an initial independent valuation performed at the beginning of the term of lease and a final independent valuation performed at the end of the term of lease. In agreements wherein the lessee makes an improvement of the property, the initial independent valuation may be performed before and/or after the improvement takes place. The valuations may be performed by a lender, by a third party approved by the lender, or by a third party chosen by the lessor and/or the lessee.

The valuations may be indexed to adjust for inflation.

The valuation procedure described above is particularly suitable for lease agreements which include a roll-over option available to the lessee at the end of the term of the lease. Alternatively, a lease agreement may be ended by financing the property by the lessor to pay out the lessee.

In another embodiment of the present invention, the lessor and the lessee may choose a lease agreement which includes the steps of selling the leased property at the end of the term of the lease. In such an agreement, the lessee may have an option to purchase the whole or part of the lessor's interest in the leased property. Also, such an agreement may give the lessee the right of first refusal on the sale of the leased property.

In the above-described embodiment, the equity based benefits may be determined by reference to capital gains on sale of the property. The capital gains may be calculated by reference to a cost base for the property, which optionally is indexed to adjust for inflation.

For leases written under the method of the present invention, it is desirable to determine equity based benefits which reflect the investment made by the lessee.

In particular, it is desirable to differentiate between a base appreciation in the value of the leased property, ie. appreciation which occurs irrespective of whether the lessee makes an investment, and an appreciation on the property which is attributable, directly or indirectly, to the lease agreement.

Similarly, cash based benefits accumulated by the lessor during the term of lease are benefits which are attributable to the lease agreement. In particular, such cash based benefits may include cash savings on agent commission and/or savings on letting fees. In addition, the cash based benefits include additional lessor's income attributable to increased occupancy rate resulting from the lease agreement. The cash based benefits may also include agreed annual increases resulting from escalator provisions in the lease agreement.

It will be apparent that the present invention may take different forms 1-12 which are summarised, without limitation, in TABLE 1.

TABLE 1

| | | | Capital |
|---|---|---|---|
| | | | Improvement and |
| Lessee's Obligation | Capital | Additional | Additional |
| Lessor's Obligation | Improvement | Payments | Payments |
| Incentive + a quantum of | 1 | 2 | 3 |
| benefits | | | |
| Capital Improvement + a | 4 | 5 | 6 |
| quantum of benefits | | | |
| Incentive + capital | 7 | 8 | 9 |
| improvement + a quantum | | | |
| of benefits | | | |
| A quantum of benefits | 10 | 11 | 12 |

To highlight the fundamental features of the present invention, an explanation of two preferred embodiments of the method and system for creating and implementing a lease agreement will now be provided by way of two specific examples. The first example, called GROWTH PARTNERS, relates to transaction 10 in TABLE 1. In this example, the lessee makes an improvement of the leased property in return for a quantum equity based benefits and cash based benefits.

The second example, called CASHFLOW PLUS, relates to transaction 2 in TABLE 1. According to this example, the lessor offers both an incentive and a quantum of equity based benefits and cash based benefits in return for additional rental payments.

It should be noted that a lender may finance both an improvement and an incentive, regardless of whether the example is GROWTH PARTNERS of CASHFLOW PLUS.

### EXAMPLE 1

GROWTH PARTNERS

In this example, the leased property is a residential property and the lease agreement is a tenancy agreement between the lessee-the tenant and the lessor-the landlord. The lessee enters into a promissory obligation to make an investment in relation to the residential property. In particular, the lessee chooses to make a renovation improvement.

Said renovation improvement must be an eligible improvement, ie. an improvement that increases the value of the leased property and continues to add value for the term of the lease and, preferably, beyond said term.

Preferably, said renovation improvement is a capital improvement, ie. “a permanent addition to the leased property of major importance and cost”.

A capital improvement could include land acquisition, construction, renovation, demolition, installation of equipment, etc. The capital improvement should possess the following characteristics:
it must increase the capital value of the leased property
it has a long, useful life or significantly extends the useful life of the leased property
it is not of routine repair/up-keep/maintenance nature
it is fixed in place or stationary
can be classified as non-recurring capital costs
it is attached to land and/or buildings in such a way that its removal would result in substantial damage to the real property.

Regional/local tax offices and land lawyers may be consulted to make sure that a proposed improvement can be classified as a capital improvement.

Examples of recommended improvements are provided in TABLE 2.

As can be seen from column 2 of TABLE 2, certain types of improvements are suitable for a roll-over option. The decision as to whether an improvement is suitable for roll-over is based on whether the improvement continues to add long-term value to the leased property. Similarly, whether the improvements are suited to unit/townhouse/villa properties and/or houses is indicated in the third and fourth columns of TABLE 2.

TABLE 2

| | Growth | | |
|---|---|---|---|
| | Partner | | |
| | Rollover | | |
| Improvement Type | Option | | House |
| Air-conditioning - Split (Reverse Cycle) | Yes | Yes | Yes |
| Air-conditioning - Ducted | Yes | No | Yes |
| Awnings | Yes | No | Yes |
| Bathroom Replacement | No | Yes | Yes |
| BBQ | Yes | Yes | Yes |
| Blinds | No | Yes | Yes |
| Carport | Yes | Yes | Yes |
| Cladding - HardiPlank | Yes | No | Yes |
| Cladding - Permalum | Yes | No | Yes |
| Cladding - Timber | Yes | No | Yes |
| Cladding - Vinyl | Yes | No | Yes |
| Curtains | No | Yes | Yes |
| Driveway Resurface/Replacement | Yes | No | Yes |
| Ducted Vacuum | Yes | No | Yes |
| Floor coverings | Yes | Yes | Yes |
| Furniture packages - Indoor | No | Yes | Yes |
| Furniture packages - Outdoor | No | Yes | Yes |
| Garage Doors - Automatic | Yes | Yes | Yes |
| Garage | Yes | No | Yes |
| Gates - Automatic | Yes | No | Yes |
| Greywater Recycling System | Yes | No | Yes |
| Gym & Fitness Equipment | No | Yes | Yes |
| Home Theatre | No | Yes | Yes |
| Hot Tub/Jacuzzi | Yes | Yes | Yes |
| Kitchen - Replacement (incl. | No | Yes | Yes |
| Whitegoods) | | | |
| Landscaping | Yes | No | Yes |
| Painting Exterior | No | No | Yes |
| Painting - Interior | No | Yes | Yes |
| Rainwater Tanks | Yes | No | Yes |
| Exterior Rendering | Yes | No | Yes |
| Roof Louvres | Yes | No | Yes |
| Roof Restoration | Yes | No | Yes |
| Sauna | Yes | No | Yes |
| Security - Alarm Only | Yes | Yes | Yes |
| Security - Gates & Fences | Yes | No | Yes |
| Security - Intercom System | Yes | No | Yes |
| Security - Shutters | Yes | Yes | Yes |
| Skylights | Yes | No | Yes |
| Smart House Technology | Yes | Yes | Yes |
| SOHO | No | Yes | Yes |
| Solar Hot Water System | Yes | No | Yes |
| Solar Electricity Cells | Yes | Yes | Yes |
| Spa Bath | Yes | Yes | Yes |
| Steam room | Yes | No | Yes |
| Swimming Pool | Yes | No | Yes |
| Swimming Pool - Solar Heating | Yes | No | Yes |
| Under Floor Heating | Yes | Yes | Yes |
| Walls, Fences & Gates | Yes | No | Yes |
| White goods packages - Kitchen | No | Yes | Yes |
| White goods packages - Laundry | No | Yes | Yes |
| Windows - Double Glazing | Yes | Yes | Yes |
| Windows & Doors Replacement | Yes | Yes | Yes |

In order to simplify the process of solution design, common elements can be packaged based on style and budget. Colour, appliance, handle co-ordination and the like should be resolved by a ‘brand name’ designer and incorporated as standard selections. Pricing can then be standardised, with estimates for fixtures such as cabinet and bench tops obtained through valuers' measurements. The example that follows demonstrates packaging solutions that could be adopted for the kitchens, however similar bundling can occur with all solutions and for full refits (e.g. carpets, paint etc) colour themes can be matched and carried throughout the home. Such solutions may be provided by a supplier of packaging solutions 100 (see FIG. 1)

Sample Study: Kitchen

It is anticipated that the core offering would not vary significantly between solutions (with the exception of colour/finish) and appliance and finishes would be bundled into price point based packages. A sample appliance package matrix appears below:

TABLE 3

| | Platnum | Gold | Silver | Bronze |
|---|---|---|---|---|
| Core Offering | | | | |
| Fridge | Jennair | Whirlpool | Fisher & Paykel | Westinghouse |
| Stove, Oven & | Miele | Smeg | Fisher & Paykel | Westinghouse |
| Rangehood | | | | |
| Sink | Blanco | Oliverie | Oliverie | Clark |
| Value- Options | | | | |
| Microwave | Panasonic | Smeg | LG | Samsung |
| Dishwasher | Miele | Whirlpool | Fisher Paykel | Westinghouse |
| Food Disposal | Insinkerator | Insinkerator | Insinkerator | Insinkerator |

The core offering would also extend to include normal items that cannot be integrated into a per square metre charge and these would include:
1×Standard Drawer Unit
1×Pot Drawer Unit
1×Pantry/Utility Cupboard
1×Range Hood Cupboard

The packages can then be priced based on a Core Package Cost plus a square metre charge covering bench tops, standard cupboards/fixtures and installation.

These appliance package, can then be integrated into themed kitchen offerings such as:

TABLE 4

| Urban | Platinum | Gold | Silver | Bronze |
|---|---|---|---|---|
| Bench Tops | Corian | Silston | Granite | Laminate |
| Doors | Polyurethane | Vacuum | Vacuum Formed | Laminate |
| | | Formed | | |
| Flooring | Premium Timber | Timber | Laminate | Vinyl |
| Tap ware | Grohe | Caroma | Dorf | Irwell |

TABLE 5

| Country | Platinum | Gold | Silver | Bronze |
|---|---|---|---|---|
| Bench Tops | Corian | Silston | Timber | Laminate |
| Doors | Timber | Vacuum | Vacuum Formed | Laminate |
| | | Formed | | |
| Flooring | Premium Timber | Timber | Laminate | Vinyl |
| Tap ware | Grohe | Caroma | Dorf | Irwell |

The improvement made by the lessee can be financed by a lender through a loan.

The total benefits arising from the agreement between the lessor and the lessee can be calculated as follows:
TOTAL BENEFITS=Equity Based Benefits+Cash Based Benefits−Cost of Loan

Preferably, the settlement principle for Growth Partners is based on an even split between the lessor and the lessee once costs have been subtracted from the benefits attributable to the relationship. In our example the quantum of interest is 0.5, ie (Capital Growth from Improvement+Agreement Based Cash Savings−Cost of Loan)/No. of Partners.

Clearly, variations can be made to what is included in the different variables to produce different settlement results. However the most equitable arrangement demands inclusion of all benefits, all costs and division of the results by two, producing an equal share to both lessor and lessee.

Growth Partners Example

Referring to TABLE 6, the original property value was $354,000 in a suburb that experienced a growth rate 10.89% per annum across the term of the lease.

TABLE 6
The property information
The Property

| | |
|---|---|
| Growth Rate Used In Model | 10.89% |
| Original Property Value | [symbol] |
| Current Weekly Rent | [symbol] |
| Number of leases signed annually | [symbol] |
| Annual Number Vacant Weeks | [symbol] |
| Current Agent Commission | [symbol] |
| Current Gross Yield | 4.04% |

The lessee funded a renovation of $27,000 financed by a lender through a loan. Details of the loan are summarised in TABLE 7. An escalator clause was agreed to by the lessor and the lessee, pursuant to which an annual rent increase of 10% was applied.

TABLE 7
The key variables of the lease agreement
The Agreement

| All Products | |
|---|---|
| Length of Agreement (years) | [symbol] |
| Annual Rental Increase | [symbol] |
| Monthly Account Fee | [symbol] |
| Loan Interest Rate | [symbol] |
| Number of Repayments Per Year | [symbol] |
| Establishment Fee | [symbol] |
| GP | |
| Cost of Incentive (Capital Improvements) | [symbol] |
| Post Improvement Expectation | [symbol] |
| Post Improvement Growth Above Spend | 18.52% |
| Loan Repayment (Capital Improvements) | 254.90 |

Under a Principal and Interest Loan structure, the loan repayments are $254.90 per fortnight. The weekly cost to the lessee appears immediately below and includes a comparison between rental costs under the agreement and costs without an agreement. The “As Is” costs carry an assumption of an annual rental increase of 5% to allow for inflation.

TABLE 8
Weekly costs to the Lessee

| | LE Agreement | | | As Is | | |
|---|---|---|---|---|---|---|
| | | | Total Rent | | Increased | Increased |
| Year | Rent | COI Loan | Costs | Rent | Cost | Cost (%) |
| 1 | 275.00 | 127.45 | 402.45 | 275.00 | 127.45 | 46% |
| 2 | 302.50 | 127.45 | 429.95 | 288.75 | 141.20 | 49% |
| 3 | 332.75 | 127.45 | 460.20 | 303.19 | 157.01 | 52% |
| 4 | 366.03 | 127.45 | 493.48 | 318.35 | 175.13 | 55% |
| 5 | 402.63 | 127.45 | 530.08 | 334.26 | 195.81 | 59% |

The summary of Totals as a result of the lease agreement under the GROWTH PARTNERS option is given in TABLE 9. Lessee and lessor both receive a Gross Benefit of $43,127. The lessors' benefit before interest and tax, but net of expenses is $26,588. The lessees' benefit before interest and tax but net of expenses is $18,657.

TABLE 9
The summary of Totals as a result of the lease agreement
The Result

| Product | Growth Partners | [symbol] |
|---|---|---|
| Base Property Value | 593,561 | [symbol] |
| Considered Property Value | 647,216 | [symbol] |
| Total Equity Based Benefit | 53,655 | [symbol] |
| Above Market Rental Value (Net Income) | 0 | [symbol] |
| Savings On Agents Commission | 6722 | [symbol] |
| Savings On Letting Fees | 3358 | 3358 |
| Annual Rental Increase Value | 15803 | 15803 |
| Increase Occupancy Value | 6716 | [symbol] |
| Total Cash Based Benefit | 32,599 | 143,759 |
| Gross Benefits | 86,254 | [symbol] |
| Cost of Loan (P + I) | 33,137 | [symbol] |
| Gross Costs | 33,137 | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| Settlement By Lessor to Lessee | 59,695 | 129,982 |

The equations used in the above tables are explained below.

Equity Based Benefits
Base Property Value=354,000 @10.89% for 5 years (compounding annually) Considered Property Value=(Post Improvement Expectation=386,000) @10.89% for 5 years (compounding annually)
Total Equity Based Benefit=Considered Property Value−Base Property Value
Cash Based Benefits
Savings On Agents Commission=(Rent1+Rent2+Rent3+Rent4+Rent5)*7.7%*52 weeks, where Rent1 is a weekly rent payable in year 1, Rent2 is a weekly rent payable in year 2, etc.
Savings On Letting Fees=(Rent1+Rent2+Rent3+Rent4+Rent5)*2 Annual Rental Increase Value=(Rent1+Rent2+Rent3+Rent4+Rent5−Current Weekly Rent*Length Of Agreement)*52weeks
Increase Occupancy Value=(Rent1+Rent2+Rent3+Rent4+Rent5)*Annual Number Vacant Weeks
Total Cash Based Benefits=Savings On Agent Commission+Savings On Letting Fees+Annual Rental Increase Value+Increase Occupancy Value
Gross Benefits=Total Equity Based Benefit+Total Cash Based Benefit
Costs
Cost of Loan=Principal+Interest
Lessee Gross Costs=Annual Rental Increase Value+Cost of Loan
Lessor Gross Costs=Cost of Loan
Gross Costs=Cost of Loan
Quantum of benefits (based on an even split)=(Gross Benefits−Gross Costs)/2

To settle the lease agreement, the lessor is required to pay $59,965(ie, Cost of Loan/2+quantum of benefits) to the lessee at end of the 5 year term.

The lessor and/or the lessee may choose an interest only loan. The comparison of an interest and principal loan with an interest only loan is given below.

The basic details of the property is given in TABLE 10 and key variables of the lease agreement are given in TABLE 11.

TABLE 10
The property information
The Property

| | |
|---|---|
| Growth Rate Used In Model | 8.19% |
| Original Property Value | [symbol] |
| Current Weekly Rent | [symbol] |
| Number of leases signed annually | [symbol] |
| Annual Number Vacant Weeks | [symbol] |
| Current Agent Commission | [symbol] |
| Current Gross Yield | 5.48% |

TABLE 11
The key variables of the lease agreement
The Agreement

| All Products | |
|---|---|
| Length Of Agreement (years) | [symbol] |
| Annual Rental Increases | [symbol] |
| Monthly Account Fee | [symbol] |
| Loan Interest Rate | [symbol] |
| Number of Repayments Per Year | [symbol] |
| Establishment Fee | [symbol] |
| GP | |
| Cost of Incentive (Capital Improvements) | [symbol] |
| Post Improvement Expectation | [symbol] |
| Post Improvement Growth Above Spend | 25.00% |
| Loan Repayment (Capital Improvements) | 291.84 |

Loan Repayments (Principal and Interest) $291.84 per fortnight.

Loan Repayments (Interest Only) $89.42 per fortnight.

The reduced weekly cost to the lessee appears immediately below and includes a comparison between rental costs under the agreement and costs without an agreement. The ‘As Is’ costs carry an assumption of an annual rental increase of 5%.

As can be seen from TABLES 12 and 13, an Interest Only loan creates lower repayments through the term of the agreement and increases the appeal to the lessee, however the principal of the loan must then be settled at completion of the lease agreement. Interest Only loans will also offer increased revenue to the lender, however that is also accompanied by increased risk.

TABLE 12
Weekly costs to the Lessee (a Principal and Interest Loan)

| | LE Agreement | | | As Is | | |
|---|---|---|---|---|---|---|
| | | | Total Rent | | Increased | Increased |
| Year | Rent | COI Loan | Costs | Rent | Cost | Cost (%) |
| 1 | 385.00 | 145.92 | 530.92 | 385.00 | 145.92 | 38% |
| 2 | 423.50 | 145.92 | 569.42 | 404.25 | 165.17 | 41% |
| 3 | 465.85 | 145.92 | 611.77 | 424.46 | 187.31 | 44% |
| 4 | 512.44 | 145.92 | 658.36 | 445.69 | 212.67 | 48% |
| 5 | 563.68 | 145.92 | 709.60 | 467.97 | 241.63 | 52% |

TABLE 13
Weekly costs to the Lessee (an Interest only Loan)

| | LE Agreement | | | As Is | | |
|---|---|---|---|---|---|---|
| | | | Total Rent | | Increased | Increased |
| Year | Rent | COI Loan | Costs | Rent | Cost | Cost (%) |
| 1 | 385.00 | 44.71 | 429.71 | 385.00 | 44.71 | 12% |
| 2 | 423.50 | 44.71 | 468.21 | 404.25 | 63.96 | 16% |
| 3 | 465.85 | 44.71 | 510.56 | 424.46 | 86.10 | 20% |
| 4 | 512.44 | 44.71 | 557.15 | 445.69 | 111.46 | 25% |
| 5 | 563.68 | 44.71 | 608.39 | 467.97 | 140.42 | 30% |

Under a Principal and Interest Loan structure, the lessee and lessor both receive a Gross Benefit of $51,533. The lessor's benefit before interest and tax, but net of expenses is $32,563. The lessee's benefit before interest and tax but net of expenses is $21,501. (see TABLE 14 ). Under an Interest Only Loan structure, the lessee and lessor still realise a Gross Benefit of $51,533, however the lessors' benefit before interest and tax, but net of expenses is $30,220. The lessees' benefit before interest and tax but net of expenses is $19,158 (see TABLE 15).

TABLE 14
Summary of Totals as a result of the lease agreement and a Principal and
Interest Loan
The Result

| Product | Growth Partners | [symbol] |
|---|---|---|
| Base Property Value | 540,928 | [symbol] |
| Considered Property Value | 598,355 | [symbol] |
| Total Equity Based Benefit | 57,427 | [symbol] |
| Above Market Rental Value (Net Income) | 0 | [symbol] |
| Savings On Agents Commission | 9411 | [symbol] |
| Savings On Letting Fees | 4701 | [symbol] |
| Annual Rental Increase Value | 22124 | 22124 |
| Increase Occupancy Value | 9402 | 9402 |
| Total Cash Based Benefit | 45,638 | [symbol] |
| Gross Benefits | 103,065 | [symbol] |
| Cost of Loan (P + I) | 37,939 | [symbol] |
| Gross Costs | 37,939 | 16,770 |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| Settlement By Lessor to Lessee | 70,502 | [symbol] |

TABLE 15
Summary of Totals as a result of the lease agreement
and an Interest Only Loan
The Result

| Product | Growth Partners | [symbol] |
|---|---|---|
| Base Property Value | 540,928 | [symbol] |
| Considered Property Value | 598,355 | [symbol] |
| Total Equity Based Improvement | 57,427 | 175,928 |
| Above Market Rental Value (Net Income) | 0 | [symbol] |
| Savings On Agents Commission | 9411 | 14887 |
| Savings On Letting Fees | 4701 | [symbol] |
| Annual Rental Increases Value | 22124 | [symbol] |
| Increase Occupancy Value | 9402 | [symbol] |
| Total Cash Based Improvement | 45,638 | 119,149 |
| Gross Benefits | 103,065 | 119,149 |
| Cost of Loan Interest Only | 11,625 | [symbol] |
| Gross Costs | 11,625 | 5.013 |
| Lessor | | |
| Gross Benefit | 51,533 | [symbol] |
| Gross Costs | 21,313 | [symbol] |
| Benefit Before Interest and Tax | 30,220 | [symbol] |
| [symbol] | [symbol] | [symbol] |
| [symbol] | [symbol] | [symbol] |
| [symbol] | [symbol] | [symbol] |
| Settlement By Lessor to Lender | 31,600 | [symbol] |
| Settlement By Lessor to Lessee | 46,720 | [symbol] |

It should be noted that $21,501 and $19,158 are actual benefits to the lessee and settlement of the agreement will take place by way of a cheque from the lessor to the lessee in the amount of $70,502 (actual benefit to the lessee+half the cost of the loan) in the case of a Principal and Interest Loan and $45,720 (actual benefit to the Lessee+half of the interest on loan) in the case of an interest only loan. The second amount is lower than the principal and interest example above, as the interest loan only results in a higher interest cost across the life to the loan. In the interest only example, the original borrowings remain unpaid so there is an outstanding debt of $31,600 ( the amount of loan+establishment fee) that the lessor would be required to take over or payout.

It is clear from the above examples, that the term of the lease is a key variable of the lease agreement. Preferably, the term of the lease is at least 5 years.

In the given examples the value of the leased property is a projected value calculated on the basis of growth rate in the suburb. Preferably, independent bank approved valuations and Quantity Surveyor recommendations should be taken into account to reduce the risk of over-capitalisation when agreeing capital improvements.

The lease agreement should also include a Early Termination Clause that requires predetermined (eg. 60 days) notice to the other party to the lease agreement. In an event of early termination by the lessee, the lessee's share will be reduced on a pro-rata basis utilising the remaining term of the agreement. Similarly, in the event of early termination by the lessor, the sharing of the cost of renovations will be pro-rated against the lessor. For example, if the lessor terminates during the first year, they bear the cost of the renovation completely. If a lessor terminates during the second year of a five-year agreement, the lessor would bear ninety percent of the cost of renovation.

At the end of the lease agreement lessor's options include:
Sell the property:
   To the lessee (less the Settlement Figure) or;
   On the open market then repay the lessee.
Retain the property and:
   Repay the lessee and relet the property.
   Refinance the entire property, drawing down the Settlement Figure or;
   Finance the Settlement through a Loan.
Where the improvement made by the lessee is qualified for a Rollover Option (eg, a swimming pool or ducted air conditioning), the lease agreement can be altered to include a rollover option or extended term.

A preferred implementation of Growth Partners includes the following Features and Characteristics; Lessor Benefits; Lessee Benefits and Settlement Options.

Features and Characteristics:
Term is 5 years.
Rollover Option not available on all lease agreements.
Independent Bank Approved Valuations and Quantity Surveyor recommendations to reduce the risk of over-capitalisation.
Lessee Early Termination Clause that requires 60 days notice to the Lessor. The lease agreement is calculated as per standard, however the Lessees share will be reduced on a pro-rata basis utilizing the remaining term of the agreement.
Lessor Early Termination Clause that requires 60 days notice to the Lessee and the lease agreement is settled as per normal methods, however the sharing of the cost of renovations will be pro-rated against the Lessor e.g. If the Lessor terminates during the first year, they bear the cost of the renovation completely. If a Lessor terminates during the second year of a five-year agreement, the Lessor would bear ninety percent of the cost of renovation.

Lessor's Benefits:
Accelerated Capital Growth
Renovations completed at half the actual cost of the renovation.
Guaranteed Cash flow for the life of the lease.
Above market, agreed annual rent increases.
Risk reduction—Attracts a quality lessee (i.e. stable, interested in property upkeep and improvement, pays rent regularly and on time)
Growth partner has a vested interest in maintaining the property in peak condition
Protection against vacancy for the life of the lease.

Lessee's Benefits:
Rent becomes an investment with Real Estate linked return.
Opportunity to live in a refurbished home in an area that they may not necessarily be able to afford to buy in.
Sense of ownership.
Quality of life.
Security through guaranteed lease terms.

It should be noted that a different accounting procedure may be used to calculate actual benefits attributable to the lease agreement. For example, such a procedure may be based on the present value of future payments, etc.

### EXAMPLE 2

Cashflow Plus

In this example, the lessor offers both an incentive and a quantum of equity based benefits and cash based benefits in return for additional rental payments made by the lessee. The incentive provided by the lessor is a short-term incentive such as a furniture package.

The criteria for selecting suitable incentives include:
Provides a high value “now” reward for the lessee.
Maintains a reasonable value or appreciates over the term of the lease agreement.
Allows for ownership to be retained by the lessor during the term of the lease.
Allows for the transfer of ownership to the lessee as may be required under the lease.

Whilst the below list is by no means conclusive, it offers a guide to the types of incentives that could be utilised under the Cashflow Plus option.
Motor Vehicles
Furniture Packages
Home Entertainment Packages
Home Office Packages
Video/Video Editing Packages
Marine Leisure Craft
Time Share Package (Holiday Accommodation/Boat)
Share Packages
White Goods Packages
Ride on Mower and Garden Tool Packages
Franchise

The lessee's quantum of benefits is determined by reference to the Yield prior to the agreement and the New Yield as a result of the agreement. This type of lease agreement is suitable for the property owners and/or investors seeking above market cash returns on a secure low maintenance investment.

The size of the incentive and the quantum of benefits are linked to the investment made by the lessee through payment of additional rent. The greater the investment made by the lessee, the greater the quantum of benefits that is allocated to the lessee, and, conversely, the smaller the investment, the lower the quantum of benefits.

Due to the volatile nature of this relationship, the lease agreement preferably contains both Minimum Return Guarantee and Maximum Return Limit cut offs to protect the lessee from poor growth and also to cap the lessor's liability at the end of the agreement.

The Minimum Return Guarantee for the lease agreement may be set by the Lender based on a “better than normal” return on the lessees' investment. For example, if a lessee had more than $10,000 available to invest, they could secure a guaranteed return of 9.95% for a fixed 5-year deposit with Australian Capital Reserve. It would therefore be reasonable to offer a Minimum Return Guarantee of 9.95% per annum. This return should prove more attractive given that the lessee would otherwise require access to over $10,000 to obtain this return (guaranteed) and this money would be inaccessible for the term of the deposit. In addition to the Minimum Return Guarantee, the lessee also receives the ownership of the incentive at the end of the lease agreement.

Preferably, the relationship between the Minimum Return Guarantee and Maximum Return Limit reflects the difference between the Old and New Yield on the property.

The same property and relevant variables have been used for the CASHFLOW PLUS examples as in the previous example relating to GROWTH PARTNERS. The original property value is $365,000 in a suburb that has undergone 8.19% growth. The lessee has agreed to commence year one rent (Rent1) at $500 per week, which is $115 above the weekly market rent for the property.

In this example, the lessor has allocated 35% of the increased rent under a Principal and Interest Loan structure, to a Home Entertainment incentive to the value of $8,116. As a result, the lessor receives $74.75 per week above market rent after paying the finance on the incentive in the first year, growing to $128.12 per week. This additional income can be used for a range of options from the simple enjoyment of lifestyle to financing a loan for other investment purposes. At 6.00% on a 30 year Principal & Interest loan an amount in excess of $50,000 could be maintained.

In this instance, the growth sustained for the property was insufficient to exceed the Minimum Return Guarantee and an amount of $45,994 is payable to the lessee under the terms of the Minimum Return Guarantee calculated at a set rate of 10% per annum. In addition to the $45,994 payment, the lessee will also take ownership of the Home Entertainment incentive, originally valued at $8,116.

The increased revenue and reduced cost of the agreement still results in a gross profit even after payment to the lessee in the magnitude of $28,499.

TABLE 16
Weekly Costs to the lessee and Benefit to lessor

| | | | Total | | | | |
|---|---|---|---|---|---|---|---|
| | | | Rent | Additional | COI | | Benefit |
| Year | Rent | Value | Costs | Income | Loan | Benefit | (%) |
| 1 | 385.00 | 115.00 | 500.00 | 115.00 | 40.25 | 74.75 | 19% |
| 2 | 423.50 | 126.50 | 550.00 | 126.50 | 40.25 | 86.25 | 20% |
| 3 | 465.85 | 139.15 | 605.00 | 139.15 | 40.25 | 96.90 | 21% |
| 4 | 512.44 | 153.07 | 665.50 | 153.07 | 40.25 | 112.82 | 22% |
| 5 | 563.68 | 168.37 | 732.05 | 168.37 | 40.25 | 128.12 | 23% |

TABLE 17
The key variables on the lease agreement
The Agreement

| All Products | |
|---|---|
| Length Of Agreement (years) | [symbol] |
| Annual Rental Increase | [symbol] |
| Monthly Account Fee | [symbol] |
| Loan Interest Rate | [symbol] |
| Number of Repayments Per Year | [symbol] |
| Establishment Foc | [symbol] |
| Agreed Weekly LE Rent | [symbol] |
| Over & Above (Tenants Weekly Investment Year 1) | 115.00 |
| CF Rent to be allocated Loan Repayment | [symbol] |
| Minimum Return Guarantee (p.a.) | [symbol] |
| CF+ | |
| Total Minimum Guarantee | 45,994 |
| Maximum Return Limit | 12.99% |
| Total Maximum Guarantee | 49,289 |
| Cost of Incentive (Non - Capital Improvements) | 8,115 |
| Loan Repayment (Non - Capital Improvements) | 80.50 |
| Cashflow Plus Equity Share Ratio | [symbol] |
| Cashflow Plus Equity Share | 12.62% |
| New Gross Yield (Less Incentive) | 6.55% |
| Change to Gross Yield (Less Incentive) | 19.42% |

TABLE 18
Summary of Totals as a result of the lease agreement
The Result

| | | Cashflow |
|---|---|---|
| Product | Growth Partners | Plus |
| Base Property Value | [symbol] | 365,000 |
| Considered Property Value | 398,355 | 540,928 |
| Total Equity Based Benefit | 57,427 | 175,928 |
| Above Market Rental Value (Net Income) | 0 | 36508 |
| Savings On Agents Commission | [symbol] | 12222 |
| Savings On Letting Fees | 4701 | 4701 |
| Annual Rental Increases Value | 22124 | 22124 |
| Increase Occupancy Value | 9402 | 9402 |
| Total Cash Based Benefit | 45,638 | 84,958 |
| Gross Benefits | 103,065 | 84,958 |
| Cost of Loan (P + 1) | [symbol] | 10,465 |
| Gross Costs | 37,939 | 10,465 |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| Settlement By Lessor to Lessee | 70.502 | 45,994 |

The equations used in the above tables are explained below.
Benefit=(Total rent−Base Rent)−loan repayment
Above Market Rental Value=(Over&Above1+Over&Above2+Over&Above3+Over&Above4+Over&Above5)*52 weeks, where Over&Above1 is the amount the Lessee has agreed to pay over and above weekly rent payable in year 1, Over&Above2 is the amount the Lessee has agreed to pay over and above weekly rent payable in year 2, etc.

The Lessor
Gross Benefit=Above Market Rental Value+Savings On Agents Commission+Savings On Letting Fees+Annual Rental Increase Value+Increase Occupancy Value
Gross Costs=Total Minimum Return Guarantee+Cost of Loan Benefit Before Interest and Tax=Gross Benefit−Gross Costs

The Lessee
Total Cash Based Benefit=Total Minimum Return Guarantee+Incentive
Gross Costs=above market Rental value

Benefit Before Interest and Tax=Gross Benefit−Gross Costs

Settlement by the lessor to the lessee=Minimum Return Guarantee

Similarly to the example relating to Growth Partners, the lessor may choose an interest only loan. Assume the lessor has allocated only 10.18% of the increased rent. In this instance, the value of the incentive is $8116 as applied in the previous principle and interest example, however the interest only structure results in reduced repayment costs. As a consequence, the lessor receives $103.21 per week above market rent after paying the finance on the incentive in the first year, growing to $156.67 per week.

The lessees' position is not altered by the lessor's decision to finance on an interest only basis

The increased revenue and reduced cost of the agreement still results in a gross profit even after payment to the lessee in the magnitude of $27,204.

TABLE 19
Weekly Costs to the Lessee and Benefit to Lessor over term

| | | | | | Benefit |
|---|---|---|---|---|---|
| Year | Rent | Value | COI Loan | Benefit | (%) |
| 1 | 385.00 | 115.00 | 11.71 | 103.29 | 27% |
| 2 | 423.50 | 126.50 | 11.71 | 114.79 | 27% |
| 3 | 465.85 | 139.15 | 11.71 | 127.44 | 27% |
| 4 | 512.44 | 153.07 | 11.71 | 141.36 | 28% |
| 5 | 563.68 | 168.37 | 11.71 | 156.67 | 28% |

TABLE 20
The Key Variables of the lease agreement
The Agreement

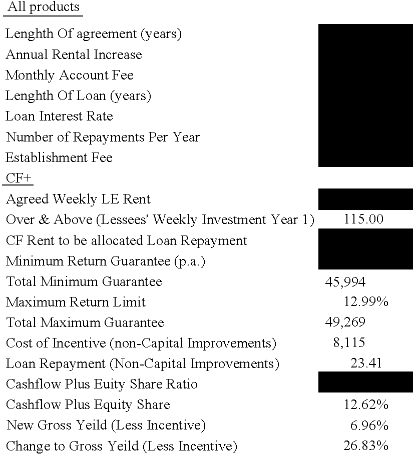

TABLE 21
Summary of Totals as a result of the Lease agreement
The Result

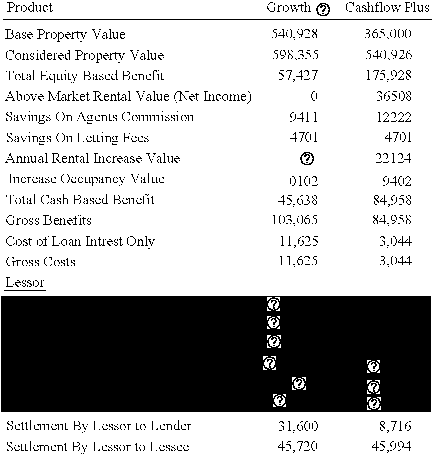

\mathring{?} indicates text missing or illegible when filed

The example below illustrates an example where a Maximum Return Guarantee was applied.

The current valuation of the property is $495,000 and the rent sought is $395 per week.

TABLE 22
The Core Property Information
The Property

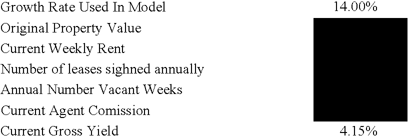

The lessee decides to invest an additional $155 per week for year one of the lease agreement. The Minimum Return Guarantee is $61,992 based on 10% per annum. The lessor allocates 30% of the Over and Above to the incentive and, seeking to maximise cashflow, finances a home theatre package costing $9,470 on an interest only basis. As a result, the lessor receives an extra $141.34 (over and above the interest payment) per week from commencement of the lease agreement, extending out to $213.28 per week in year five.

TABLE 23
Weekly Costs to the Lessee and Benefit to
Lessor over term

| | | | | | Benefit |
|---|---|---|---|---|---|
| Year | Rent | Value | COI Loan | Benefit | (%) |
| 1 | 395.00 | 155.00 | 13.66 | 141.34 | 36% |
| 2 | 434.50 | 170.50 | 13.66 | 158.84 | 36% |
| 3 | 477.95 | 167.55 | 13.66 | 173.89 | 36% |
| 4 | 525.75 | 206.31 | 13.66 | 192.86 | 37% |
| 5 | 578.32 | 226.94 | 13.66 | 213.28 | 37% |

TABLE 24
The Key Variables of the lease agreement
The Agreement

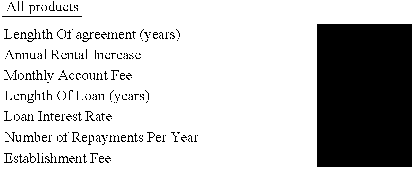

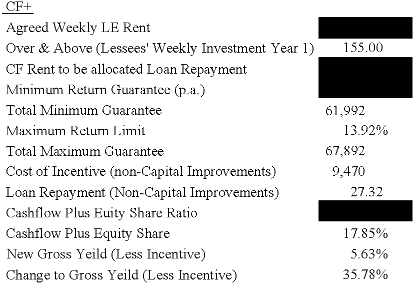

Due to the strong continued growth in the area, the Maximum Return Limit has engaged and to settle the lease agreement the lessor is required to draw down $67,892 for the lessee. This settlement represents a 13.92% p.a. return on his investment. Additionally, the lessee also retains ownership of the Home Entertainment Package, originally costing $9,470.

TABLE 25
Summary of Totals as a result of the lease agreement
The Result

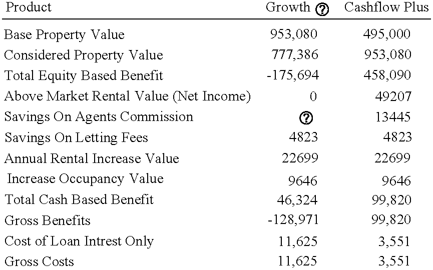

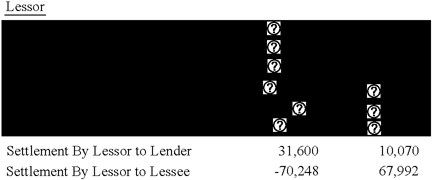

\mathring{?} indicates text missing or illegible when filed

Lessor:
Gross Costs=Maximum Return Limit+Cost of Loan Interest Only+Establishment Fee+Incentive
Settlement by the Lessor to the Lender=Incentive+Establishment Fee
Settlement by the Lessor to the Lessee+Maximum Return Limit

The Lessor's options include:
Sell the property:
   To the lessee (less the Settlement Figure) or;
   On the open market then repay the lessee the Settlement.
      OR
Retain the property and:
   Rollover the lease agreement.
   or;
   Relet the property.
   and;
   Refinancing the entire property, drawing down the Settlement Figure or;
   Finance the Settlement through a Payout Loan.
   or;
   Fund the Settlement through cash savings or investments.

A preferred implementation of Cashflow Plus includes the following Features and Characteristics; Lessor Benefits; Lessee Benefits and Settlement Options.

Features and Characteristics:
Terms between 5 and 25 years with rollover options.
Lessee retains ownership of the Incentive at the end of the lease agreement provided there is no default on any terms of the lease agreement (rent payable and finance payments) by the lessee during the term of the agreement.
Lessee Early Termination Clause that requires 60 days notice to the lessor. The lease agreement is calculated as per standard, however the lessee's share will be reduced on a pro-rata basis utilising the remaining term of the agreement.
Lessor Early Termination Clause that requires 60 days notice to the lessee and the lease agreement is settled on a pro-rated basis as per normal methods. The lessor transfers ownership of the incentive to the lessee provided there is no default on any terms of the lease agreement during the executed term of the agreement. If the lessee has breached a term that disqualifies them from taking ownership of the incentive, then the lessor Early Termination Clause is superseded by the breach. In such circumstances the lessor retains ownership of the incentive.

Lessor Benefits:
Increased Cash flow through above market rental return
Guaranteed Cash flow for the life of the lease.
Above market, agreed annual rent increases.
Risk reduction—Attracts a quality lessee (i.e. stable, interested in property upkeep and improvement, pays rent regularly and on time)
Growth partner has a vested interest in maintaining the property in peak condition
Protection against vacancy for the life of the lease.
Lifestyle—Rent includes new furnishings or other Incentive, which the lessee keeps at the end of the term providing they have complied with the terms of the lease agreement.
Sense of ownership.
Quality of life.
Security through guaranteed lease terms.
Rent becomes an investment with Real Estate linked return.

In one preferred embodiment of the present invention the method for creating and implementing a lease agreement includes the step of third party matching of lease applicants with property owners. Said matching may be performed by a lender.

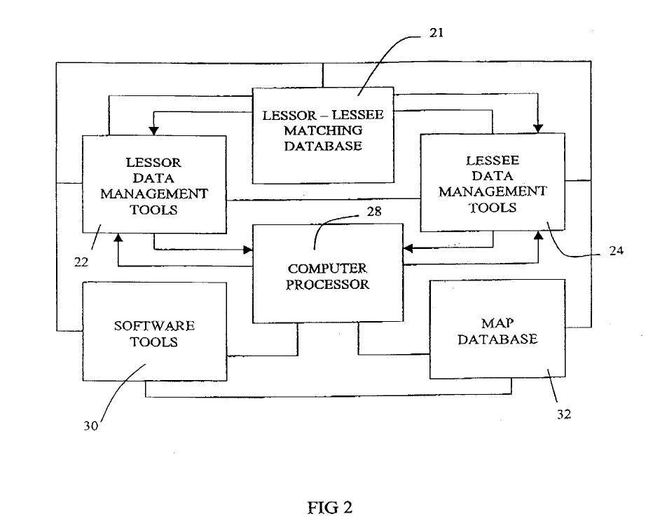

Referring now specifically to the drawings, a method of matching a lessee with a lessor according to the present invention is illustrated in diagram form in FIG. 2. The method includes the following primary sub-methods or “steps”: 1) creating a lessor-lessee matching database 21; 2) providing lessor data management tools 22 allowing an operator to manage property data in said database, including the steps of creating-a property description and creating and modifying data for said property description; 3) providing lessee data management tools 24 for an operator to create and modify a property profile of a lease applicant by indicating property characteristics specific to a lessee; 4) accessing said lessor-lessee matching database; 5) forming a property query using said database and said property characteristics; and 6) searching said property data in said lessor-lessee database to return properties compatible with said property query.

Said step of matching said lessor with said lessee may include the steps of forming a property characteristics query using said database and said property description, and searching said property characteristics in said lessor-lessee database to return property characteristics compatible with said property characteristics query.

In the preferred embodiment illustrated in FIG. 2 the step of third party matching of lease applicants with property owners includes the step of creating the lessor-lessee matching database in a form readable by a computer processor 28. In such a computer-implemented embodiment of the present invention software tools 30 may be provided for forming the property query or the property characteristics query and searching the lessor-lessee database. The software described herein is also executed on computer processor 28.

The following example relates to an operator acting on behalf of a lending institution in an indirect financing process of a lease agreement relating to a residential property.

In the present example, a property owner who is a customer of a lending institution desires to make a capital improvement to his home through a lease agreement written under the method of the present invention using indirect financing obtained through the lending institution. To implement the step of matching the property owner with potential lease applicants, the lessor-lessee matching database operator requires a computer processor with suitable hardware and software configured to receive and distribute information to the lending institution computer, for example over a local area network or the Internet. The programming software provides graphical user interface and application-specific entry forms or interactive windows. Other required system hardware includes a keyboard, mouse, monitor, communications equipment such as a modem, and at least one line of communication with all other users and system components.

Front end I/O tools such as HTML, XTML, JAVA, ASP or other similar network software is used to create various functional screens for the matching database operator on a wide-area network (eg Internet) allowing secure remote access to the lending institution web site through interfaces.

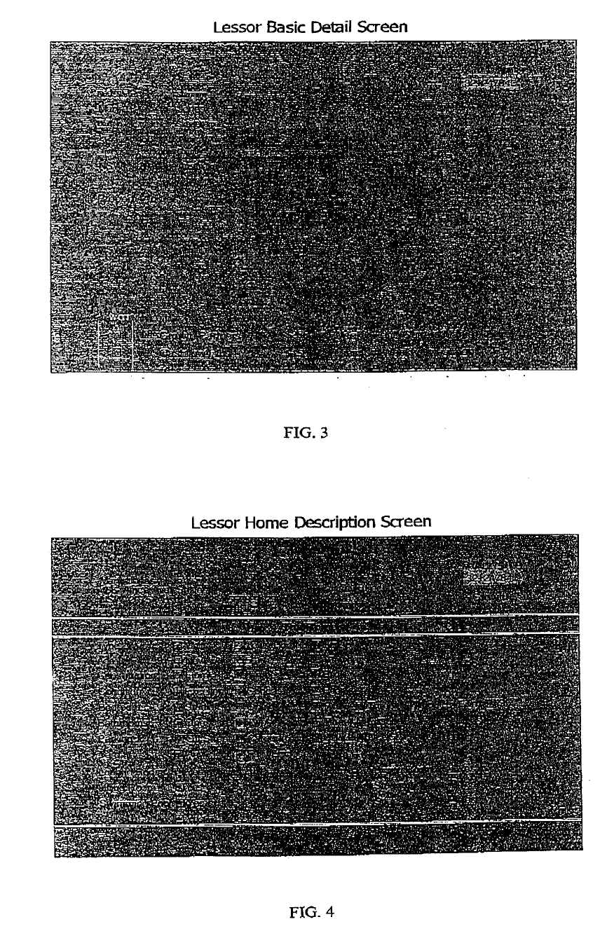

A potential lessor may use a PC to connect to the lending institution web site through the lessor basic detail interface illustrated at FIG. 3. Alternatively, the prospective lessor may contact the lending institution and be put in contact with the database operator.

A Lessor Basic Detail screen of a user interface shows a general layout of the functional screen for entering lessor information. The screen contains separate text boxes for entering the basic details relating to prospective lessors wishing to enter into a lease agreement and seeking suitable lessees. The basic details include the name, the address and contact details of the lessor and the address of the property.

The database operator is also prompted to include a weighting on lessor preferred lease agreement types: GROWTH PARTNERS and CASHFLOW PLUS. In addition, the Lessor Basic Detail screen includes boxes for entering the value of current weekly rent and minimum weekly investment under the CASHFLOW PLUS option.

The user receives a Reference Number for use when modifying an existing property description and/or accessing the lessor-lessee matching database.

FIG. 4 shows a Lessor Home Description screen for creating a property description. The screen contains functions for creating a property description and for creating and modifying data for said property description. The client enters onto a form the details of the property. In a lease agreement relating to a residential property, the property may be described by specifying one or more of the following: type of property; age of property; material of construction; condition of the property; the number of bedrooms; the number of bathrooms; the availability and/or description of lounge room; the availability and/or description of living room; the availability and/or description of dining room; the availability and/or description of study; the availability and/or description of parking; the availability and/or description of yard; the availability and/or description of swimming pool; the availability and/or description of spa; the availability and/or description of internal laundry; whether or not a pet animal is allowed, additional notes, etc.

In addition, the description of the property may include additional details (not shown) such as a preferable term of lease; an investment contribution; type of said investment contribution; an incentive provided by said lessor; a quantum of equity based benefits; a quantum of cash based benefits; whether the property is furnished; views, images of the property, etc.

The Lessor basic details entered onto the Lessor Basic Detail screen are linked to and displayed at the Lessor Home Description screen. The Home Description screen also allows changing of the description of the property.

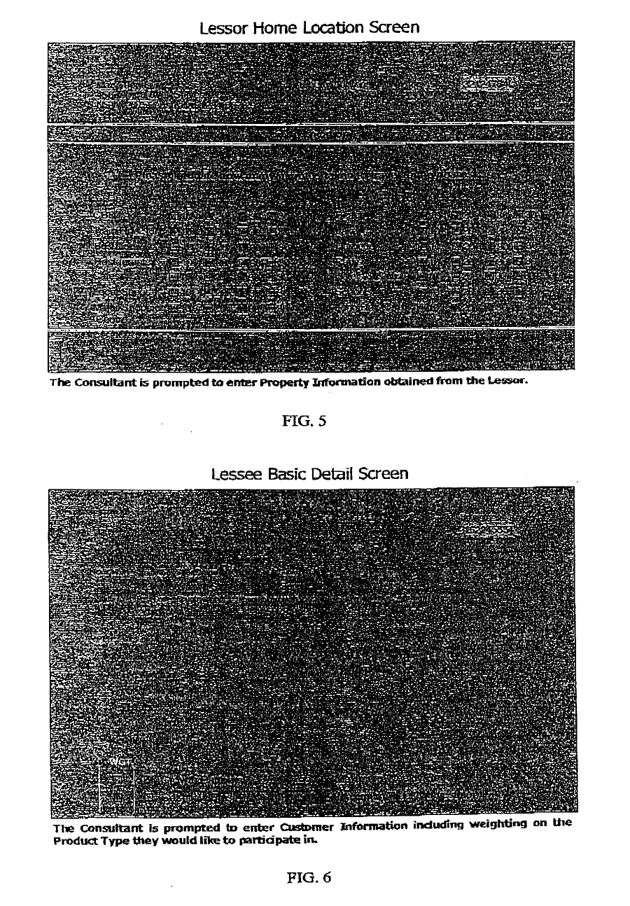

FIG. 5 shows a Lessor Home Location screen for creating a property description in terms of location. The screen contains functions for entering time values required to travel to the nearest location point. The location points may include one or more of the following: CBD; train line; bus line; restaurants; cafes; local shops; major shopping centres; beach; lakes; harbour; hotels; clubs; schools; childcare facilities, etc.

The computer processor (see FIG. 2) receives the data specifying the property description and lessor basic details and automatically saves the data in a lessor-lessee matching database for subsequent matching with prospective lease applicants.

The information provided by the Lessor may be used for querying the lessor-lessee matching database to automatically select suitable prospective lessees, ie lessees whose property profile is compatible with the property description specified by the lessor (the operation of the computer system will be described below).

After selection of prospective lessees, the lessor initiates a contact with the lessor-lessee matching database provider by either telephone contact or selecting an option within the on-line interface (not shown) requesting that the provider contacts him or her.

Preferably, a potential lessee uses a PC to connect to the lending institution web site through a lessee basic detail interface illustrated at FIG. 6. Alternatively, the prospective lessee may contact the lending institution and be put in contact with the database operator. The layout and functionality of the lessee interface is similar to those of the lessor interface. The prospective lessee also receives a Reference Number which may be used for accessing the lessor-lessee database and for changing lessee details.

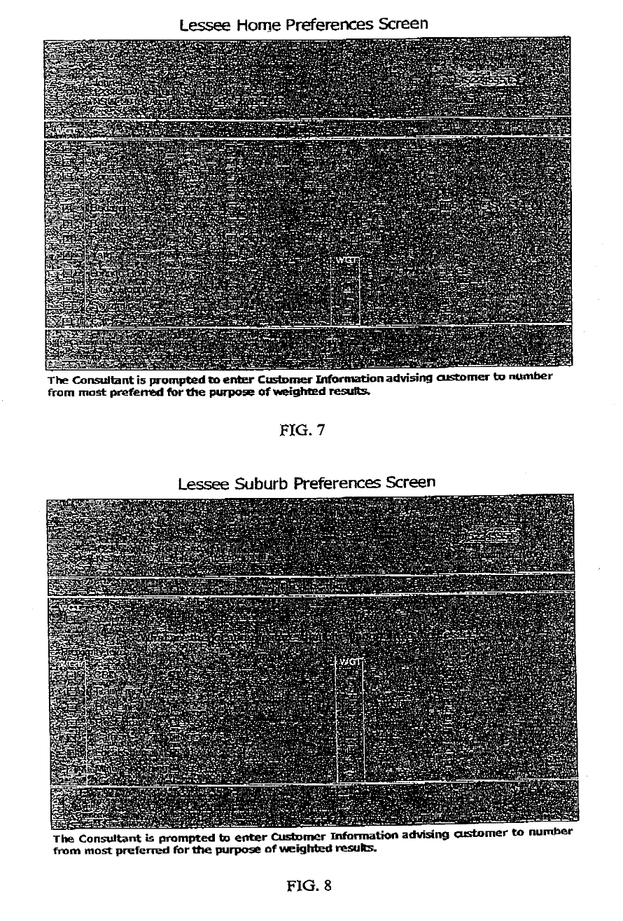

With reference to FIG. 7, the prospective lessee then enters onto a Lessee Home Preferences screen data relating to property characteristics specific to that lessee. The items of description of the property are identical to the items included in Lessor Home Description screen. In addition, the lessee Home Preferences screen prompts the lessee to enter preference numbers into boxes representing the items of the property description for the purpose of obtaining weighted results. For example, the prospective lessee may indicate a preference for 4 bedrooms, although he or she only requires 3 bedrooms.

Further, the prospective lessee identifies suburb preferences by accessing a Lessee Suburb Preferences screen illustrated in FIG. 8. The lessee may enter the name of a preferred suburb. In addition, the lessee may specify the location features that are important to the lessee by answering Yes or No in boxes corresponding to the location features. The location features are identical to those presented in the Lessor Home Location screen. The lessee is also prompted to number the location features from the most preferred for the purpose of obtaining weighted results.

FIG. 9 shows a Lessee Home Location Preferences screen. The screen allows the lessee to indicate preferences on how many minutes are taken to travel to the nearest location feature. In addition, the lessee numbers the location features from the most preferred for obtaining weighted results.

The action areas of the Lessee screens (not shown) contain the functions for submitting and canceling the lessee request.

After the prospective lessee submits the above described information to the computer system, that information is saved in the database. The data provided by the lessee forms search terms for querying the lessor-lessee matching database to automatically select available properties compatible with the property profile specified by the prospective lessee (the operation of the computer system will be described below).

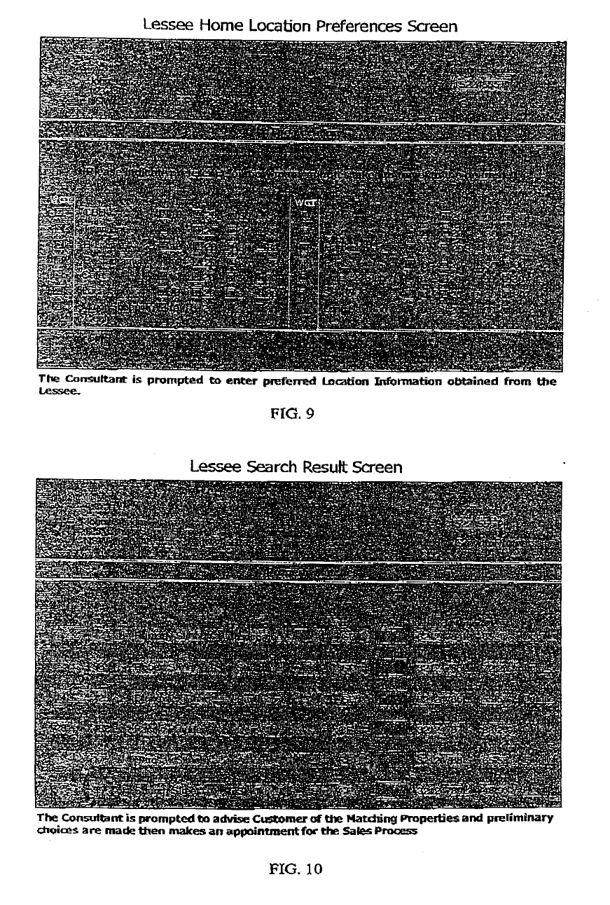

Referring to FIG. 10, when the lessor-lessee matching database is queried, it returns, in the form of a table, a summary of search results matching specified property profile. These search results represent a plurality of properties which can be suitable for the prospective lessee. The search results are sorted and presented in descending order based on their weighted index score with the most relevant items at the top of the list.

The summary of selected properties is linked to the descriptions of the properties and can be expanded to access the details and images of each property.

The lessee chooses the properties it wishes to inspect and then contacts the prospective lessor using the lessor contact details and negotiates the details of the inspection. Alternatively, computer system may be configured in such a way as to require the lessee to contact the database operator or lending institution to arrange a meeting with the selected lessor/s. Alternatively, the lessee may select an option within the screen showing search results summary (not shown) requesting that the provider of the lessor-lessee matching database contacts him or her.

Once a proposal from a prospective lessor/lessee is accepted and finalised into a lease agreement, the lessor or the lending operator would remove the property description from the lessor-lessee matching database. Alternatively, the property may be flagged to not appear under available properties to prevent/facilitate future re-entry and/or to retain customer history. Similar arrangements also apply to lessee details. The records become inactive for the term of the lease, however at the end of the agreement or as the lease approaches completion, the records are flagged as prospective leads and a trigger initiated to the lending institution. The status of these records is editable to allow them to be moved to active, ie. Seeking a Partner.

The computer system has the primary function of determining whether the property profile entered by the prospective lessee matches the property descriptions entered by prospective lessors, both in terms of preferred lease agreements and geographical location. In cases where the property profile is specified by using the location features, the step of matching property owner with lease applicants may require a further step of accessing a map database to identify geographical areas containing the location features preferred by the prospective lessee.

The computer system then determines whether properties available in the identified geographical areas match the lessee home preferences. To accomplish this, the computer system performs a search through the property descriptions originating from the identified areas to give the prospective lessee a list of properties matching the property profile specific to the lessee.

A separate ‘dating’ service may be established to facilitate the matching of potential lessors with potential lessees. The lessor-lessee database may be interfaced with the dating service to exchange information relating to (lessor and lessee) contact and location details, status (ie, looking for lease/matched/unmatched and expiring, matched and expired), warnings and file notes, lease agreement commencement and expiry dates.

In one preferred embodiment the method for creating and implementing a lease agreement further includes the step of using a computer system for preparing lease documents specifying equity based benefits. Preferably, said method also includes the step of using a computer system for preparing lease documents specifying cash based benefits.

The following is an outline of the major data, processes and uses of the computer system for preparing lease documents.

Preferably, the step of using the computer system includes the following sub-steps: (1) inputting data into the computer system regarding terms of the lease agreement, including an amount of rental payments and a term of lease; (2) using said computer system to calculate payment obligations of the lessee accruing under the lease agreement; (3) using the computer system to prepare one or more lease documents which specify (1) equity based benefits, (2) cash based benefits, (3) that lessee is to make an investment in relation to said property,(4) that the lessee is entitled to share in a quantum of said benefits, and (5) calculation basis for said equity and cash based benefits.

The lease documents may specify that the lessor is to sell said property. Also, the lease agreement documents may specify that payment of all obligations owed by the lessor to the lessee is synchronized with the sale of the property subject to the lease.

Preferably, the lease documents specify an upper limit on the quantum of the benefits available to the lessee or/and a minimum total guaranteed return for the lessee. Preferably, the minimum total guaranteed return for the lessee is determined by reference to a predetermined annual return on the average lessee's contribution outstanding during the lease period. Preferably, the lease documents specify that the maximum return limit is calculated by reference to the difference between the old and the new yield on said property and reference to the minimum total guaranteed return. The minimum total guaranteed return and the maximum return limit may be specified in absolute terms, eg. $15,000. Alternatively, these amounts may be expressed in percentage terms, eg. 15%.

Preferably, the above-described process of generating lease agreement documents is implemented on a computer system including at least one computer including a processor and a memory, for receiving data regarding the terms of the lease. The data includes an amount of rental payments, a term of lease, and agreed annual rental increase (an escalator clause). In addition, the data includes a reference to a particular lease agreement option chosen by the lessor and the lessee, for example, GP(GROWTH PARTNERS), CF+(CASHFLOW PLUS) or other lease agreement according to the present invention. If the investment/the incentive is financed through a lender, the data will additionally include data relating to a loan such as a monthly account fee, a loan interest rate, a number of repayment per year, an establishment fee, etc.

The computer operator then enters key variables specific to the particular lease agreement chosen by the lessor and the lessee. The key variables are given in TABLES 7,11,17,20,and 24 “The Key Variables of the Lease Agreement”, discussed above in relation to the GROWTH PARTNERS and CASHFLOW PLUS examples.

The computer calculates periodic payment obligations of the lessee accruing under the lease agreement. The results of the calculations are illustrated in TABLES 8,12,13,16,19,and 23, “Weekly Costs to the Lessee and Benefit to Lessor over the term”.

The computer then prepares one or more lease documents which include a promissory obligation by the lessor of the leased property to share with the lessee a quantum of equity based benefits attributable to said agreement and which specify: (1) equity based benefits, (2) that lessee is to make an investment in relation to said property, and (3) that the lessee is entitled to share in a quantum of said benefits. Preferably the computer system prepare documents which further include a promissory obligation by the lessor of the leased property to share with the lessee a quantum of cash based benefits attributable to said agreement and which specify the cash based benefits attributable to the agreement.

The examples of calculations of the equity based benefits and cash based benefits are illustrated in the TABLES 9,14,15,18,21,and 25 “Summary of Totals as a result of the Lease agreement”. In calculating the benefits the computer system uses the property information given in TABLES 6,10,and 22,“The Core Property Information” and/or other information relating to empirical data on current letting fees, agent commission, growth rate in a particular suburb, and the like.

Preferably, the computer system further includes at least one server computer configured to connect to a network for transferring and receiving data relating to said lease agreement and the first computer is connected to said network for transferring and receiving said data thereover. The server computer may be a Web server configured to connect to the internet and to send a message over the internet, said message relating to said lease agreement. Also, the server computer may be configured to connect to at least one network to receive and transfer said lease documents over said network. The server may be a Web server.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein. It will further be understood that any reference herein to known prior art does not, unless the contrary indication appears, constitute an admission that such prior art is commonly known by those skilled in the art to which the invention relates.

1. A method for creating and implementing a lease agreement between a lessor of an income generating property and a lessee of said property and preparing lease agreement documents specifying payment obligations of said lessee to said lessor concerning said property which is subject to said lease agreement including the steps of: determining an amount of rent payable and a term of lease; creating a promissory obligation by the lessor of said property to share with the lessee a quantum of benefits attributable to said agreement, said benefits being selected from the group consisting of equity based benefits and cash based benefits; and creating a promissory obligation by the lessee to make an investment in relation to said property, in addition to said rent payable, in consideration for said lessor's promissory obligation.

2. A method according to claim 1 wherein said payment obligations are based on an escalating scale.

3. A method for creating and implementing a lease agreement between a lessor of an income generating property and a lessee of said property and preparing lease agreement documents specifying payment obligations of said lessee to said lessor concerning said property which is subject to said lease agreement including the steps of: determining an amount of rent payable and a term of lease; creating a promissory obligation by the lessor of said property to share with the lessee a quantum of equity based benefits attributable to said agreement; and creating a promissory obligation by the lessee to make an investment in relation to said property, in addition to said rent payable, in consideration for said lessor's promissory obligation.

4. A method according to claim 3 further including the step of creating a promissory obligation by the lessor of said property to share with the lessee a quantum of cash based benefits attributable to said agreement.

5. A method according to claim 1 wherein said lessor is the owner of said property.

6. A method according to claim 1 wherein said lessor is a lessee of a master lease of said property and said lease agreement is a sub-lease of said property.

7. A method according to claim 1 wherein said lessor is a part-owner of said property with said lessee.

8. A method according to claim 1 wherein said promissory obligation by the lessee includes an obligation to make an improvement of the property which is subject to the lease agreement.

9. A method according to claim 8 wherein said improvement is specified in a package, said package matched to a particular type of said property.

10. A method according to claim 8 wherein said improvement is a capital improvement.

11. A method according to claim 8 wherein said improvement is a renovation of the property which is subject to the lease agreement.

12. A method according to claim 1 wherein said lessee's obligation includes an obligation to make additional rental payments.

13. A method according to claim 12 wherein said additional rental payments are based on an escalating scale.

14. A method according to claim 2 wherein said escalating scale includes variable rental increase rate and/or variable frequency of rental increases.

15. A method according to claim 14 wherein said rental increase rate is equal to a multiple of two times market average rate.

16. A method according to claim 14 wherein said frequency of rental increases is one rental increase per annum.

17. A method according to claim 1 further including the step of creating a loan agreement between said lessor and a lender, said loan agreement creating a promissory obligation by said lender to lend to said lessor, directly or indirectly, a loan amount in relation to said lease agreement.

18. A method according to claim 1 further including the step of creating a loan agreement between the lessee and a lender, said loan agreement creating a promissory obligation by the lender to lend to the lessee, directly or indirectly, a loan amount in relation to said lease agreement.

19. A method according to claim 1 wherein said equity based benefits are determined on the basis of assessments of the value of the property at the beginning and at the end of the lease.

20. A method according to claim 19 wherein at least one of said assessments is performed by reference to market value of said property.

21. A method according to claim 20 wherein said market value is a sale price of said property.

22. A method according to claim 19 wherein at least one of said assessments is performed by reference to valuation of said property.

23. A method according to claim 22 wherein said equity based benefits are determined on the basis of change in valuation of said property between an initial independent valuation performed at the beginning of said term of lease and a final independent valuation performed at the end of said term of lease.

24. A method according to claim 23 wherein the lessee makes an improvement to the property and said initial independent valuation is performed before and after said improvement takes place.

25. A method according to claim 23 wherein said final valuation is indexed to allow for inflation.

26. A method according to claim 23 wherein said valuations are performed by a lender.

27. A method according to claim 23 wherein said valuations are performed by a third party approved by a lender.

28. A method according to claim 23 wherein said valuations are performed by a third party chosen by the lessor and/or the lessee.

29. A method according to claim 19 wherein the assessments of the value of the property at the beginning and at the end of the lease are of the same nature—either both are market set values or both are independent valuations.

30. A method according to claim 1 wherein said equity based benefits are capital gains.

31. A method according to claim 30 wherein said capital gains are calculated by reference to a cost base for said property.

32. A method according to claim 31 wherein said cost base is indexed to allow for inflation.

33. A method according to claim 1 wherein said cash based benefits include agreement based cash savings accumulated by the lessor.

34. A method according to claim 33 wherein said cash savings include savings on agent commission and/or savings on letting fees.

35. A method according to claim 1 wherein said cash based benefits include lessor's income attributable to increased occupancy rate.

36. A method according to claim 2 wherein said cash benefits include lessor's income attributable to said escalating scale provisions.

37. A method according to claim 1 further including the step of creating a promissory obligation by the lessor to provide an incentive in relation to said agreement.

38. A method according to claim 37 wherein said incentive is a gift by said lessor to said lessee.

39. A method according to claim 37 wherein a loan agreement is entered by the lessor and a lender, said loan agreement creating a promissory obligation by said lender to lend a loan amount in relation to said incentive.

40. A method according to claim 39 wherein said interest payments on said loan are made by said lessee.

41. A method according to claim 37 wherein said incentive includes a non-capital improvement of the property which is subject to said lease.

42. A method according to claim 1 further including the step of creating a promissory obligation by the lessor to make a capital improvement of the property which is subject to said lease agreement.

43. A method according to claim 42 wherein a loan agreement is entered by said lessor and a lender, said loan agreement creating a promissory obligation by said lender to lend a loan amount in relation to said capital improvement.

44. A method according to claim 1 wherein performance of said lessor's obligation is due at the end of said term of lease.

45. A method according to claim 1 wherein said term of said lease is at least 5 years.

46. A method according to claim 1 further including the step of creating a roll-over option available to the lessee at the end of said term of lease.

47. A method according to claim 1 further including the step of selling of the property subject to said lease agreement.

48. A method according to claim 47 wherein said lease agreement gives the lessee an option to purchase the whole or part of the lessor's interest in said property.

49. A method according to claim 47 wherein said lease agreement gives the lessee the right of first refusal on said sale of the property.

50. A method according to claim 1 further including the step of financing said property by the lessor to pay out the lessee.

51. A method according to claim 50 wherein a loan agreement between said lessor and a lender is entered into, said loan agreement creating a promissory obligation by said lender to lend a loan amount in relation to said pay out.

52. A method according to claim 12 further including the step of determining a minimum guaranteed amount payable by the lessor to the lessee under said lessor's obligation.

53. A method according to claim 52 wherein said minimum guaranteed amount is determined by reference to a pre-determined annual return on the average lessee's investment outstanding during said lease agreement.

54. A method according to claim 53 further including the step of setting a maximum return limit on said lessor's obligation.

55. A method according to claim 54 wherein said maximum return limit is calculated by reference to the difference between the old and the new yield on said property and by reference to said minimum guaranteed amount.

56. A method according to claim 1 further including a Sub Let Clause that allows the Lessee to sublet the property to a Sub-Lessee with written consent of the Lessor.

57. A method according to claim 56 wherein said consent to sub-lease does not release the Lessee from any obligations under the lease agreement and does not it entitle the Sub-Lessee to make any claims against the original lessor.

58. A method according to claim 1 wherein said lease agreement further includes a Reinstatement Clause providing that any cleaning and/or damage repair above normal wear and tear is the responsibility of the Lessee and will be subtracted from the settlement amount prior to the payment to the Lessee.

59. A method according to claim 1 further including the step of third party matching of said lessor with said lessee.

60. A method according to claim 59 wherein said matching is performed by a lender.

61. A method according to claim 59 wherein said step of matching said lessor with said lessee includes the steps of
creating a lessor-lessee matching database;
providing lessor data management tools allowing an operator to manage property data in said database, including the steps of
creating a property description, and
creating and modifying data for said property description;
providing lessee data management tools for an operator to create and modify property characteristics specific to a lessee;
accessing said lessor-lessee matching database;
forming a property query using said database and said property characteristics; and
searching said property data in said lessor-lessee database to return properties compatible with said property query.

62. A method according to claim 61 wherein said step of matching said lessor with said lessee further includes the steps of: forming a property characteristics query using said database and said property description, and searching said property characteristics in said lessor-lessee database to return property characteristics compatible with said property characteristics query.

63. A method according to claim 61 wherein search results are sorted and presented in descending order based on their weighted index score with the most relevant items at the top of the list.

64. A method according to claim 61 wherein said lessor-lessee matching database is created in a form readable by a computer processor.

65. A method according to claim 61 wherein, in the creation and implementation of a lease agreement relating to a residential property, said lessor data management tools includes means for describing said property by specifying one or more of the following: the name of the lessor; the address of the lessor; the contact details of the lessor; an amount of rental payments; a term of lease; an investment contribution; type of said investment contribution; an incentive provided by said lessor; a quantum of equity based benefits; a quantum of cash based benefits; the address of the property; type of property; age of property; material of construction; condition of the property; whether the property is furnished; the number of bedrooms; the number of bathrooms; the availability and/or description of lounge room; the availability and/or description of living room; the availability and/or description of dining room; the availability and/or description of study; the availability and/or description of parking; the availability and/or description of yard; the availability and/or description of swimming pool; the availability and/or description of spa; the availability and/or description of internal laundry; whether or not a pet animal is allowed; views; images of the property, additional comments.

66. A method according to claim 61 wherein, in the creation and implementation of a lease agreement relating to a residential property, said lessee data management tools include means for specifying property characteristics specific to a lessee by specifying one or more of the following: the name of the lessee; the address of the lessee; the contact details of the lessee; an amount of rental payments; an investment contribution; type of said investment contribution; an incentive to be provided by a lessor; a preferable location of property; type of property; age of property; material of construction; condition of the property; the number of bedrooms; the number of bathrooms; the availability and/or description of lounge room; the availability and/or description of living room; the availability and/or description of dining room; the availability and/or description of study; the availability and/or description of parking; the availability and/or description of yard; the availability and/or description of swimming pool; the availability and/or description of spa; a pet animal; additional comments.

67. A method according to claim 66 wherein said preferable location is indicated by specifying lessee preferences on proximity to one or more nearest preference points, such preference points including one or more of the following: proximity to CBD; proximity to train line; proximity to bus line; proximity to restaurants; proximity to cafes; proximity to local shops; proximity to major shopping centres; proximity to beach; proximity to lakes; proximity to harbour; proximity to hotels; proximity to clubs; proximity to schools; proximity to childcare facilities.

68. A method according to claim 1 wherein said method further includes the step of using a computer system for preparing lease documents specifying equity based benefits.

69. A method according to claim 68 further including the step of using a computer system for preparing lease documents specifying cash based benefits.

70. A method according to claim 69 wherein said step of using said computer system includes the steps of:
inputting data into said computer system regarding terms of said lease, including an amount of rental payments and a term of lease;
using said computer system to calculate said payment obligations of said lessee accruing under said lease agreement;
using the computer system to prepare one or more lease documents which specify (1) equity based benefits, (2) cash based benefits; (3) that lessee is to make an investment in relation to said property, (4) that the lessee is entitled to share in a quantum of said benefits, and (5) calculation basis for said equity and cash based benefits.

71. A method according to claim 68 wherein said lease documents specify that the lessor is to sell said property.

72. A method according to claim 71 wherein said lease agreement documents specify that payment of all obligations owed by the lessor to the lessee is synchronised with the sale of the property subject to the lease.

73. A method according to claim 69 wherein said lease agreement documents specify an upper limit on said benefits or/and a minimum total guaranteed return for the lessee.

74. A method according to claim 73 wherein said minimum total guaranteed return for the lessee is determined by reference to a predetermined annual return on the average lessee's contribution outstanding during the lease period.

75. A method according to claim 73 wherein said maximum return limit is calculated by reference to the difference between the old and the new yield on said property and reference to the minimum total guaranteed return.

76. A lessor-lessee matching database computer system including a computer processor; a lessor-lessee matching database containing property data relating to a plurality of lessors in a form readable by said processor; property data stored in said database; database management tools to manage said property data in said database including: a tool for creating a property description and a tool for creating and modifying data for said property description; database management tools to manage data relating to property characteristics specific to a plurality of lessees; a software tool using said database and said property characteristics to form a property query; and a search tool searching said property data in said lessor-lessee matching database to return property descriptions compatible with said property query.

77. A system according to claim 76 further including a software tool using said database and said property description to form a property characteristics query, and a search tool searching said property characteristics in said lessor-lessee database to return property characteristics compatible with said property characteristics query.

78. A system according to claim 76 further including a map database.

79. A system according to claim 76 further including at least one server computer configured to connect to a network for transferring and receiving data relating to said lessor-lessee database and wherein the computer processor and the database management tools are connected to the network for transferring and receiving said data thereover.

80. A system according to claim 79 wherein said server computer is a Web server configured to connect to the internet and to send a message over the internet, said message relating to data relating to the lessor-lessee matching database.

81. A computer system for preparing lease agreement specifying payment obligations of a lessee to a lessor concerning an income generating property which is subject to a lease, the lease agreement including a promissory obligation by the lessor of said property to share with the lessee a quantum of equity based benefits attributable to said agreement, said computer system including
at least one computer including a central processing unit and a memory, for receiving data regarding the terms of the lease, including an amount of rental payments and a term of lease, within the computer system;
at least one computer calculating periodic payment obligations of the lessee accruing under said lease agreement, and preparing one or more lease documents which include a promissory obligation by the lessor of said property to share with the lessee a quantum of equity based benefits attributable to said agreement and which specify: (1) equity based benefits, (2) that lessee is to make an investment in relation to said property, and (3) that the lessee is entitled to share in a quantum of said benefits.

82. A system according to claim 81 wherein said computer system prepares documents which further include a promissory obligation by the lessor of said property to share with the lessee a quantum of cash based benefits attributable to said agreement and which specify the cash based benefits attributable to the agreement.

83. A system according to claim 81 further including at least one server computer configured to connect to a network for transferring and receiving data relating to said lease agreement and wherein said client computer is connected to said network for transferring and receiving said data thereover.

84. A system according to claim 83 wherein said server computer is a Web server configured to connect to the internet and to send a message over the internet, said message relating to said lease agreement.

85. A system according to claim 84 wherein said server computer is configured to connect to at least one network to receive and transfer said lease documents over said network.

86. A method according to claim 1 further including the step of surrendering or reducing said quantum of said benefits if rent payments and/or finance repayments are not made as agreed.

87. A method according to claim 17 wherein said loan is an interest only loan.

88. A method according to claim 17 wherein the interest rate of said loan is variable.

89. A method according to claim 17 wherein the interest rate of said loan is fixed.

90. A method according to claim 17 wherein said loan agreement entered by the lessor is serviced and/or guaranteed by the lessee and vice versa.
